(19) United States
(12) Patent Application Publication
(10) Pub. No.: US 2025/0326958 A1
(43) Pub. Date: Oct. 23, 2025

(54) EPOXY RESIN-BASED ADHESIVE COMPOSITION

(71) Applicant: IIDA INDUSTRY CO., LTD., Inazawa-shi (JP)

(72) Inventors: Yusa YOSHIMURA, Inazawa-shi (JP); Kazunari TAKAKI, Inazawa-shi (JP)

(21) Appl. No.: 19/063,805

(22) Filed: Feb. 26, 2025

(30) Foreign Application Priority Data
Apr. 18, 2024 (JP) 2024-067661

(51) Int. Cl. C09J 163/00; C09J 171/02

(52) U.S. Cl. CPC C09J 163/00; C09J 171/02

(57) ABSTRACT

An epoxy resin-based adhesive composition used for a vehicle includes a bisphenol A epoxy resin, a polyalkylene glycol diglycidyl ether, a dimer acid diglycidyl ester, and a compound having a phenol group.

### CROSS-REFERENCE TO RELATED APPLICATIONS

This application is based upon and claims the benefit of priority from Japanese Patent Application No. 2024-067661, filed on Apr. 18, 2024, the entire contents of which are incorporated herein by reference.

### BACKGROUND

### 1. Field

The present disclosure relates to an epoxy resin-based adhesive composition.

### 2. Description of Related Art

Japanese Laid-Open Patent Publication No. 2018-069658 describes an adhesive structural body including an adhesive layer. The adhesive layer may be formed from, for example, an epoxy resin-based adhesive.

It may be desirable for a vehicle such as an automobile to have a structure that reduces vibration, thereby, for example, enhancing riding comfort. In an example, when the vehicle has an adhesive structure including an adhesive layer, enhancement of the vibration damping property of the adhesive layer may also be desired.

It is an objective of the present invention to provide an epoxy resin-based adhesive composition that enhances the vibration damping property of an adhesive layer used for a vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure provides an epoxy resin-based adhesive composition used for a vehicle. The epoxy resin-based adhesive composition includes a bisphenol A epoxy resin, a polyalkylene glycol diglycidyl ether, a dimer acid diglycidyl ester, and a compound having a phenol group.

Other features and aspects will be apparent from the following detailed description, the drawings, and the claims.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment of an epoxy resin-based adhesive composition will now be described.

An epoxy resin-based adhesive composition used for a vehicle includes a bisphenol A epoxy resin, a polyalkylene glycol diglycidyl ether, a dimer acid diglycidyl ester, and a compound having a phenol group. The epoxy resin-based adhesive composition may include a curing agent, a curing accelerator, core-shell rubber particles, a blocked urethane resin, and the like.

### Bisphenol A Epoxy Resin

The bisphenol A epoxy resin may be a commercially available product. The bisphenol A epoxy resin may be a solid resin, which is solid at a room temperature, or a liquid resin, which is liquid at a room temperature. The bisphenol A epoxy resin may be formed of one type or a combination of two or more types. Preferably, the bisphenol A epoxy resin is a liquid resin, which is liquid at a room temperature. The room temperature is, for example, 20° C.±15° C. Examples of the commercially available product of the bisphenol A epoxy resin include “NPEL-128” manufactured by Nan Ya Plastics Corporation, “jER828” manufactured by Mitsubishi Chemical Corporation, “YD-128” manufactured by NIPPON STEEL Chemical & Material Co., Ltd., and “EPICLON 850” manufactured by DIC Corporation.

### Polyalkylene Glycol Diglycidyl Ether

Examples of polyalkylene glycol diglycidyl ether include polyethylene glycol diglycidyl ether, polypropylene glycol diglycidyl ether, and polytetramethylene glycol diglycidyl ether. The polyalkylene glycol diglycidyl ether may be formed of one type or a combination of two or more types.

### Dimer Acid Diglycidyl Ester

The dimer acid diglycidyl ester is a divalent epoxy-based polymer obtained by reaction of a dimer acid with epichlorohydrin. The dimer acid is a dicarboxylic acid produced by the dimerization of unsaturated fatty acids. The unsaturated fatty acid has, for example, 18 carbon atoms. Examples of the unsaturated fatty acid include oleic acid and linoleic acid. The dimer acid diglycidyl ester may be a commercially available product.

### Compound Having Phenol Group

Examples of the compound having a phenol group include alkyl phenol, alkenyl phenol, distyrenated phenol, methylstyrenated phenol, and phenol resin. The alkyl group of the alkyl phenol has, for example, 1 to 20 carbon atoms. The alkyl group may be linear or branched. Examples of the alkenyl phenol include cardanol and cardanol oligomer. Examples of the phenol resin include resol resin and novolac resin. The compound having a phenol group may be formed of one type or a combination of two or more types.

### Content of Above-Described Components

In the epoxy resin-based adhesive composition, assuming 100 parts by mass of the bisphenol A epoxy resin, the content of the polyalkylene glycol diglycidyl ether is, preferably, in a range of 10 parts by mass to 60 parts by mass, inclusive, and, more preferably, in a range of 20 parts by mass to 50 parts by mass, inclusive.

In the epoxy resin-based adhesive composition, assuming 100 parts by mass of the bisphenol A epoxy resin, the content of the dimer acid diglycidyl ester is, preferably, in a range of 10 parts by mass to 60 parts by mass, inclusive, and, more preferably, in a range of 20 parts by mass to 50 parts by mass, inclusive.

In the epoxy resin-based adhesive composition, assuming 100 parts by mass of the bisphenol A epoxy resin, the total content of the polyalkylene glycol diglycidyl ether and the dimer acid diglycidyl ester is, preferably, in a range of 40 parts by mass to 90 parts by mass, inclusive, and, more preferably, in a range of 50 parts by mass to 80 parts by mass, inclusive.

In the epoxy resin-based adhesive composition, assuming 100 parts by mass of the bisphenol A epoxy resin, the content of the compound having a phenol group is, preferably, in a range of 50 parts by mass to 90 parts by mass, inclusive, and, more preferably, in a range of 60 parts by mass to 80 parts by mass, inclusive.

In an example, in the epoxy resin-based adhesive composition, the total content of the bisphenol A epoxy resin, the polyalkylene glycol diglycidyl ether, the dimer acid diglycidyl ester, and the compound having a phenol group is, preferably, 10 mass percent or greater, more preferably, 15 mass percent or greater, and, further preferably, 20 mass percent or greater.

In an example, in the epoxy resin-based adhesive composition, the total content of the bisphenol A epoxy resin, the polyalkylene glycol diglycidyl ether, the dimer acid diglycidyl ester, and the compound having a phenol group has an upper limit that is 95 mass percent or less, 90 mass percent or less, or 85 mass percent or less.

### Curing Agent

Examples of the curing agent include hydrazide, amide compound, amino carboxylic acid, amine adduct, and polyamine. Examples of the hydrazide include adipic acid dihydrazide, sebacic acid dihydrazide, dodecanediohydrazide, isophthalic acid dihydrazide, and salicylic acid hydrazide. Examples of the amide compound include dicyandiamide and polyamide. Examples of the amino carboxylic acid include 6-aminohexanoic acid, 7-aminoheptanoic acid, 11-aminoundecanoic acid, and 12-aminolauric acid. The curing agent may be formed of one type or a combination of two or more types.

Preferably, the curing agent includes dicyandiamide. In the epoxy resin-based adhesive composition, assuming 100 parts by mass of the bisphenol A epoxy resin, the content of the curing agent is, preferably, in a range of 8 parts by mass to 24 parts by mass, inclusive, and, more preferably, in a range of 10 parts by mass to 14 parts by mass, inclusive. When the content of the curing agent is 8 parts by mass or greater, the adhesive strength is further increased. When the content of the curing agent is 24 parts by mass or less, the storage stability is enhanced.

### Curing Accelerator

Examples of the curing accelerator include urea-based curing accelerator and imidazole-based curing accelerator. Examples of the urea-based curing accelerator include monouron, diuron, isophoronebis urea, methylenediphenyl bisdimethyl urea, phenyl dimethyl urea, and toluene bisdimethyl urea. Examples of the imidazole-based curing accelerator include 2-ethyl-4-methylimidazole, 2-phenylimidazole, 1-(2-cyanoethyl)-2-ethyl-4-methylimidazole, 2-phenylimidazoline, and 2,4-diamino-6-[2′-methylimidazolyl-(1′)]-ethyl-s-triazine isocyanuric acid adduct. The curing accelerator may be formed of one type or a combination of two or more types.

In the epoxy resin-based adhesive composition, assuming 100 parts by mass of the bisphenol A epoxy resin, the content of the curing accelerator is, preferably, in a range of 1 part by mass to 10 parts by mass, inclusive, and, more preferably, in a range of 3 parts by mass to 8 parts by mass, inclusive. When the content of the curing accelerator is 1 part by mass or greater, the adhesive strength is further increased. When the content of the curing accelerator is 10 parts by mass or less, the storage stability is enhanced.

### Core-Shell Rubber Particle

The core-shell rubber particle includes a core layer formed of rubber and a shell layer covering the periphery of the core layer. Examples of the core layer of the core-shell rubber particle include olefin-based rubber, butadiene rubber, urethane rubber, acrylic rubber, and silicone rubber. Examples of the shell layer of the core-shell rubber particle include acrylic resin and styrene resin. The core-shell rubber particle may be formed of one type or a combination of two or more types.

In the epoxy resin-based adhesive composition, assuming 100 parts by mass of the bisphenol A epoxy resin, the content of the core-shell rubber particle is, preferably, in a range of 10 parts by mass to 100 parts by mass, inclusive, and, more preferably, in a range of 20 parts by mass to 60 parts by mass, inclusive. When the content of the core-shell rubber particle is 10 parts by mass or greater, the strength of the adhesive layer is further increased. When the content of the core-shell rubber particle is 100 parts by mass or less, the storage stability is enhanced.

### Blocked Urethane Resin

The blocked urethane resin is obtained by obtaining polyurethane resulting from reaction of a polyhydroxy compound and an excess of a polyisocyanate compound and blocking the polyurethane with a blocking agent.

Examples of the polyhydroxy compound include polyether diol, polyether triol, polytetramethylene ether glycol, polyester polyol, and polycarbonate diol.

Examples of the polyisocyanate compound include hexane diisocyanate, a polymer of hexane diisocyanate, toluene diisocyanate, xylene diisocyanate, diphenylmethane diisocyanate (monomeric, polymeric, or hydrogenated), and isophorone diisocyanate.

Examples of the blocking agent include monohydric alcohol (e.g., ethanol, propanol, butanol, and pentanol), phenol, nonylphenol, p-tert-butylphenol, methyl ethyl ketone oxime, and ε-caprolactam. The blocking agent may be formed of one type or a combination of two or more types.

In the epoxy resin-based adhesive composition, assuming 100 parts by mass of the bisphenol A epoxy resin, the content of the blocked urethan resin is, preferably, in a range of 10 parts by mass to 60 parts by mass, inclusive, and, more preferably, in a range of 20 parts by mass to 50 parts by mass, inclusive. When the content of the blocked urethan resin is 10 parts by mass or greater, the adhesion strength is further increased. When the content of the blocked urethan resin is 60 parts by mass or less, decreases in the elastic modulus are limited.

### Filler

Examples of the filler include calcium carbonate, silica, glass beads, glass milled fiber, talc, kaolin, bentonite, wollastonite, mica, calcium oxide, and mineral products. Examples of the calcium carbonate include heavy calcium carbonate and light calcium carbonate. The filler is, for example, spherical, plate-shaped, needle-shaped, or flake-shaped. The filler may be a surface-processed product in which the surface of an above-described substance is processed. The filler may be formed of one type or a combination of two or more types.

In the epoxy resin-based adhesive composition, assuming 100 parts by mass of the bisphenol A epoxy resin, the content of the filler is, preferably, in a range of 300 part by mass to 600 parts by mass, inclusive, and, more preferably, in a range of 400 parts by mass to 500 parts by mass, inclusive. When the content of the filler is 300 parts by mass or greater and the epoxy resin-based adhesive composition is applied to obtain a coating layer, the fluidity of the coating layer is further limited. When the content of the filler is 600 parts by mass or less, decreases in the applicability of the epoxy resin-based adhesive composition are limited.

### Method for Manufacturing and Using Epoxy Resin-Based Adhesive Composition

An example of a method for manufacturing and using the epoxy resin-based adhesive composition will now be described.

The epoxy resin-based adhesive composition may be prepared by mixing the raw materials described above. The epoxy resin-based adhesive composition may be prepared using a mixing device. Examples of the mixing device include, for example, a bead mill, a grinder, a pot mill, a three-roll mill, a rotary mixer, and a biaxial mixer.

When using the epoxy resin-based adhesive composition, an applying step is performed first. The applying step applies the epoxy resin-based adhesive composition to a first panel that is a component of a vehicle. The epoxy resin-based adhesive composition is applied by, for example, an applicator gun. Then, a second panel that is a component of the vehicle is disposed on the coating layer of the epoxy resin-based adhesive composition applied to the first panel. This obtains a laminated structure including the first panel, the second panel and the coating layer sandwiched between the first panel and the second panel. The first panel and the second panel are, for example, a metal panel. Examples of the metal panel include a steel plate and an aluminum plate. Examples of the steel plate include a carbon steel plate and a stainless steel plate. The first panel and the second panel form, for example, a lower structure of the vehicle. The first panel and the second panel may be joined by joining portions such as spot welding as necessary.

The vehicle having the laminated structure sequentially undergoes a cleaning step, an electrodeposition coating step, and a baking step. The baking step bakes an electrodeposition coating film using a furnace. The baking step is used to heat and cure the coating layer of the laminated structure. This obtains an adhesive layer formed of the cured coating layer. The adhesive layer of the laminated structure is disposed between the first panel and the second panel and adhered to the first panel and the second panel. In the baking step, the heating temperature is, for example, in a range of 140° C. to 220° C., inclusive, and the heating time is, for example, in a range of 20 minutes to 60 minutes, inclusive.

### Operation and Advantages of Present Embodiment

The operation and advantages of the present embodiment will now be described.

(1) A epoxy resin-based adhesive composition used for a vehicle includes a bisphenol A epoxy resin, a polyalkylene glycol diglycidyl ether, a dimer acid diglycidyl ester, and a compound having a phenol group. This configuration enhances the vibration damping property of an adhesive layer in the vehicle. The vibration damping property of the adhesive layer is determined by, for example, measuring the dynamic viscoelasticity of the adhesive layer. The measurement of the dynamic viscoelasticity of the adhesive layer determines that, for example, the vibration damping property of the adhesive layer is increased as the value of loss tangent (tan δ) at 23° C. and the value of loss tangent (tan δ) at 40° C. are increased.

(2) In the epoxy resin-based adhesive composition, assuming 100 parts by mass of the bisphenol A epoxy resin, the content of the polyalkylene glycol diglycidyl ether is, preferably, in a range of 10 parts by mass to 60 parts by mass, inclusive. In the epoxy resin-based adhesive composition, assuming 100 parts by mass of the bisphenol A epoxy resin, the content of the dimer acid diglycidyl ester is, preferably, in a range of 10 parts by mass to 60 parts by mass, inclusive. In the epoxy resin-based adhesive composition, assuming 100 parts by mass of the bisphenol A epoxy resin, the total content of the polyalkylene glycol diglycidyl ether and the dimer acid diglycidyl ester is, preferably, in a range of 40 parts by mass to 90 parts by mass, inclusive. In the epoxy resin-based adhesive composition, assuming 100 parts by mass of the bisphenol A epoxy resin, the content of the compound having a phenol group is, preferably, in a range of 50 parts by mass to 90 parts by mass, inclusive. In this case, the vibration damping property of the adhesive layer in the vehicle is further enhanced.

(3) In the epoxy resin-based adhesive composition, assuming 100 parts by mass of the bisphenol A epoxy resin, the content of the polyalkylene glycol diglycidyl ether is, more preferably, in a range of 20 parts by mass to 50 parts by mass, inclusive. In the epoxy resin-based adhesive composition, assuming 100 parts by mass of the bisphenol A epoxy resin, the content of the dimer acid diglycidyl ester is, more preferably, in a range of 20 parts by mass to 50 parts by mass, inclusive. In the epoxy resin-based adhesive composition, assuming 100 parts by mass of the bisphenol A epoxy resin, the total content of the polyalkylene glycol diglycidyl ether and the dimer acid diglycidyl ester is, more preferably, in a range of 50 parts by mass to 80 parts by mass, inclusive. In the epoxy resin-based adhesive composition, assuming 100 parts by mass of the bisphenol A epoxy resin, the content of the compound having a phenol group is, more preferably, in a range of 60 parts by mass to 80 parts by mass, inclusive. In this case, the vibration damping property of the adhesive layer in the vehicle is further enhanced.

### EXAMPLES

Embodiments and comparative examples will now be described.

### Embodiments 1 to 23 and Comparative Examples 1 to 3

The raw materials shown in Tables 1 to 3 and other components are kneaded using a kneader to prepare an epoxy resin-based adhesive composition of each embodiment and each comparative example. In Tables 1 to 3, the unit of a numerical value showing the composition amount of each raw material is parts by mass. In each embodiment and each comparative example, the epoxy resin-based adhesive composition includes a curing agent, a curing accelerator, and a filler as other components. In the epoxy resin-based adhesive composition of each embodiment and each comparative example, the composition amount of the curing agent is 12 parts by mass. The composition amount of the curing accelerator is 6 parts by mass. The composition amount of the filler is 400 parts by mass.

The raw materials shown in Tables 1 to 3 will be described in detail below.

(A) “NPEL-128” manufactured by Nan Ya Plastics Corporation was used as the bisphenol A epoxy resin.

(B) Polyethylene glycol diglycidyl ether (Epolight 400E manufactured by Kyoeisha Chemical Co., Ltd.) was used as the polyalkylene glycol diglycidyl ether.

(C) “ERISYS GS-120” manufactured by Huntsman was used as the dimer acid diglycidyl ester.

(D) Distyrenated phenol (KUMANOX 3112 manufactured by Kumho Petrochemical Co., Ltd.) was used as the compound having a phenol group. Alternatively, for example, “DSP” manufactured by Yokkaichi Synthetic Co., Ltd. may be used as the compound having a phenol group.

Dicyandiamide (OMICURE DDA5 manufactured by Huntsman) was used as the curing agent, which is included in other components described above.

Diuron (UR200 manufactured by Alzchem) was used as the curing accelerator, which is included in other components described above.

Heavy calcium carbonate (LW-350 manufactured by Shimizu Industrial Co., Ltd.) was used as the filler, which is included in other components described above.

### Dynamic Viscoelasticity Measurement

The epoxy resin-based adhesive composition of Example 1 was applied to a first steel plate. A spacer having a thickness of 2 mm was mounted on the first steel plate. Then, the second steel plate was disposed to overlap the first steel plate. This obtains a laminated body. The laminated body was heated at 170° C. for 30 minutes. This cures the epoxy resin-based adhesive composition and obtains an adhesive structure including an adhesive layer. The obtained adhesive structure was cut to obtain a sample of an adhesive layer having a length of 40 mm, a width of 6 mm, and a thickness of 2 mm.

The dynamic viscoelasticity of the sample was measured using a dynamic viscoelasticity measurement device (DMA7100 manufactured by Hitachi High-Tech Science Corporation). The measurement conditions were as follows.
Deformation Mode: Tension Mode (Sinusoidal Wave)
Frequency: 1 Hz
Chuck Distance: 20 mm
Amplitude: 10 μm
Measurement Temperature: −20° C. to 100° C.
Temperature Increase Rate: 1° C./min

In the same manner as Example 1, for Examples 2 to 23 and Comparative Examples 1 to 3, samples of the epoxy resin-based adhesive compositions were prepared, and the dynamic viscoelasticity of each sample was measured.

### Vibration Damping Property Evaluation 1

Values of loss tangent (tan δ) obtained by the viscoelasticity measurement described above (23° C.) were used to obtain vibration damping property evaluation 1 based on the following determination criteria. Tables 1 to 3 show the results of the vibration damping property evaluation 1.
Excellent (a): Loss tangent (tan δ) is 0.13 or greater at 23° C.
Good (b): Loss tangent (tan δ) is 0.1 or greater and less than 0.13 at 23° C.
Poor (c): Loss tangent (tan δ) is less than 0.1 at 23° C.

### Vibration Damping Property Evaluation 2

Values of loss tangent (tan δ) obtained by the viscoelasticity measurement described above (40° C.) were used to obtain vibration damping property evaluation 2 based on the following determination criteria. Tables 1 to 3 show the results of the vibration damping property evaluation 2.
Excellent (a): Loss tangent (tan δ) is 0.4 or greater at 40° C.
Good (b): Loss tangent (tan δ) is 0.3 or greater and less than 0.4 at 40° C.
Poor (c): Loss tangent (tan δ) is less than 0.3 at 40° C.

TABLE 1

| | Examples | | | | | | | | |
|---|---|---|---|---|---|---|---|---|---|
| | 1 | 2 | 3 | 4 | 5 | 6 | 7 | 8 | 9 |
| (A) Bisphenol A | 100 | 100 | 100 | 100 | 100 | 100 | 100 | 100 | 100 |
| Epoxy Resin | | | | | | | | | |
| (B) Polyalkylene Glycol | 10 | 10 | 20 | 20 | 30 | 40 | 50 | 60 | 60 |
| Diglycidyl Ether | | | | | | | | | |
| (C) Dimer Acid | 30 | 40 | 20 | 30 | 30 | 30 | 30 | 30 | 20 |
| Diglycidyl Ester | | | | | | | | | |
| (D) Compound having | 70 | 70 | 70 | 70 | 70 | 70 | 70 | 70 | 70 |
| Phenol Group | | | | | | | | | |
| Total Amount of (B) and (C) | 40 | 50 | 40 | 50 | 60 | 70 | 80 | 90 | 80 |
| Vibration Damping | b | b | b | a | a | a | a | a | a |
| Property Evaluation 1 | | | | | | | | | |
| Vibration Damping | a | a | a | a | a | a | a | b | b |
| Property Evaluation 2 | | | | | | | | | |

TABLE 2

| | Examples | | | | | | | | | |
|---|---|---|---|---|---|---|---|---|---|---|
| | 10 | 11 | 12 | 13 | 14 | 15 | 16 | 17 | 18 | 19 |
| (A) Bisphenol A Epoxy Resin | 100 | 100 | 100 | 100 | 100 | 100 | 100 | 100 | 100 | 100 |
| (B) Polyalkylene Glycol | 30 | 40 | 30 | 30 | 30 | 30 | 40 | 50 | 20 | 30 |
| Diglycidyl Ether | | | | | | | | | | |
| (C) Dimer Acid Diglycidyl Ester | 10 | 10 | 20 | 30 | 40 | 50 | 50 | 40 | 60 | 60 |
| (D) Compound having Phenol Group | 70 | 70 | 70 | 70 | 70 | 70 | 70 | 70 | 70 | 70 |
| Total Amount of (B) and (C) | 40 | 50 | 50 | 60 | 70 | 80 | 90 | 90 | 80 | 90 |
| Vibration Damping Property Evaluation | b | b | a | a | a | a | a | a | a | a |
| 1 | | | | | | | | | | |
| Vibration Damping Property | a | a | a | a | a | a | a | b | b | b |
| Evaluation 2 | | | | | | | | | | |

TABLE 3

| | Examples | | | | Comparative Ex. | | |
|---|---|---|---|---|---|---|---|
| | 20 | 21 | 22 | 23 | 1 | 2 | 3 |
| (A) Bisphenol A Epoxy Resin | 100 | 100 | 100 | 100 | 100 | 100 | 100 |
| (B) Polyalkylene Glycol Diglycidyl Ether | 30 | 30 | 30 | 30 | — | 30 | 30 |
| (C) Dimer Acid Diglycidyl Ester | 30 | 30 | 30 | 30 | 30 | — | 30 |
| (D) Compound having Phenol Group | 50 | 60 | 80 | 90 | 70 | 70 | — |
| Vibration Damping Property Evaluation 1 | b | a | a | a | c | c | c |
| Vibration Damping Property Evaluation 2 | a | a | a | b | c | c | c |

As shown in Tables 1 to 3, in Examples 1 to 23, the evaluations 1 and 2 of the vibration damping property indicate that the results were excellent or good. In Comparative Example 1, which does not include polyalkylene glycol diglycidyl ether, the evaluations 1 and 2 of the vibration damping property indicate worse results than those of Examples 1 to 23. In Comparative Example 2, which does not include dimer acid diglycidyl ester, and Comparative Example 3, which does not include a compound having a phenol group, the results were worse than those of Examples 1 to 23.

In Examples 4 to 7, 12 to 15, 21, and 22, the evaluations 1 and 2 of the vibration damping property indicate the results were excellent.

### Consideration 1-1: Polyalkylene Glycol Diglycidyl Ether

Samples were prepared in the same manner as Examples 1 to 23 except that the polyethylene glycol diglycidyl ether used in Examples 1 to 23 was changed to polyethylene glycol diglycidyl ether (Denacol EX-832 manufactured by Nagase ChemteX) manufactured by a different manufacturer. The dynamic viscoelasticity of each sample was measured. In this case, the evaluations 1 and 2 of the vibration damping property indicate the results were equivalent to those of Examples 1 to 23.

### Consideration 1-2: Polyalkylene Glycol Diglycidyl Ether

The polyethylene glycol diglycidyl ether used in Examples 1 to 23 was changed to polypropylene glycol diglycidyl ether (Epogosey-PG400 manufactured by Yokkaichi Chemical Co., Ltd.). Except for this change, samples were prepared in the same manner as Examples 1 to 23, and the dynamic viscoelasticity of each sample was measured. In this case, the evaluations 1 and 2 of the vibration damping property also indicate the results were equivalent to those of Examples 1 to 23.

### Consideration 1-3: Polyalkylene Glycol Diglycidyl Ether

The polyethylene glycol diglycidyl ether used in Examples 1 to 23 was changed to polytetramethylene glycol diglycidyl ether (Epogosey-PT manufactured by Yokkaichi Chemical Co., Ltd.). Except for this change, samples were prepared in the same manner as Examples 1 to 23, and the dynamic viscoelasticity of each sample was measured. In this case, the evaluations 1 and 2 of the vibration damping property also indicate the results were equivalent to those of Examples 1 to 23.

### Consideration 2-1: Dimer Acid Diglycidyl Ester

Samples were prepared in the same manner as Examples 1 to 23 except that the dimer acid diglycidyl ester used in Examples 1 to 23 was changed to dimer acid diglycidyl ester (jER 871 manufactured by Mitsubishi Chemical Corporation) manufactured by a different manufacturer. The dynamic viscoelasticity of each sample was measured. In this case, the evaluations 1 and 2 of the vibration damping property also indicate the results were equivalent to those of Examples 1 to 23.

### Consideration 2-2: Dimer Acid Diglycidyl Ester

Samples were prepared in the same manner as Examples 1 to 23 except that the dimer acid diglycidyl ester used in Examples 1 to 23 was changed to dimer acid diglycidyl ester (YD-171 manufactured by Kukdo Chemical) manufactured by a different manufacturer. The dynamic viscoelasticity of each sample was measured. In this case, the evaluations 1 and 2 of the vibration damping property also indicate the results were equivalent to those of Examples 1 to 23.

### Consideration 3-1: Compound Having Phenol Group

Samples were prepared in the same manner as Examples 1 to 23 except that the distyrenated phenol used in Examples 1 to 23 was changed to cardanol oligomer (CD-5L manufactured by Tohoku Chemical Co., Ltd.). The dynamic viscoelasticity of each sample was measured. In this case, the evaluations 1 and 2 of the vibration damping property also indicate the results were equivalent to those of Examples 1 to 23.

### Consideration 3-2: Compound Having Phenol Group

Samples were prepared in the same manner as Examples 1 to 23 except that the distyrenated phenol used in Examples 1 to 23 was changed to methylstyrenated phenol (HiRENOL PL1000-S manufactured by Kolon). The dynamic viscoelasticity of each sample was measured. In this case, the evaluations 1 and 2 of the vibration damping property also indicate the results were equivalent to those of Examples 1 to 23.

### Combination of Raw Materials

The raw materials used in determinations 1-1 to 1-3, the raw materials used in determinations 2-1 and 2-2, and the raw materials used in determinations 3-1 and 3-2 were combined to prepare samples in the same manner as Examples 1 to 23. The dynamic viscoelasticity of each sample was measured. In this case, the evaluations 1 and 2 of the vibration damping property also indicate the results were equivalent to those of Examples 1 to 23.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An epoxy resin-based adhesive composition for a vehicle, the epoxy resin-based adhesive composition comprising:
a bisphenol A epoxy resin;
a polyalkylene glycol diglycidyl ether;
a dimer acid diglycidyl ester; and
a compound having a phenol group.

2. The epoxy resin-based adhesive composition according to claim 1, wherein
a content of the polyalkylene glycol diglycidyl ether is in a range of 10 parts by mass to 60 parts by mass, inclusive, assuming 100 parts by mass of the bisphenol A epoxy resin,
a content of the dimer acid diglycidyl ester is in a range of 10 parts by mass to 60 parts by mass, inclusive, assuming 100 parts by mass of the bisphenol A epoxy resin,
a total content of the polyalkylene glycol diglycidyl ether and the dimer acid diglycidyl ester is in a range of 40 parts by mass to 90 parts by mass, inclusive, assuming 100 parts by mass of the bisphenol A epoxy resin, and
a content of the compound having a phenol group is in a range of 50 parts by mass to 90 parts by mass, inclusive, assuming 100 parts by mass of the bisphenol A epoxy resin.

3. The epoxy resin-based adhesive composition according to claim 1, wherein
a content of the polyalkylene glycol diglycidyl ether is in a range of 20 parts by mass to 50 parts by mass, inclusive, assuming 100 parts by mass of the bisphenol A epoxy resin,
a content of the dimer acid diglycidyl ester is in a range of 20 parts by mass to 50 parts by mass, inclusive, assuming 100 parts by mass of the bisphenol A epoxy resin,
a total content of the polyalkylene glycol diglycidyl ether and the dimer acid diglycidyl ester is in a range of 50 parts by mass to 80 parts by mass, inclusive, assuming 100 parts by mass of the bisphenol A epoxy resin, and
a content of the compound having a phenol group is in a range of 60 parts by mass to 80 parts by mass, inclusive, assuming 100 parts by mass of the bisphenol A epoxy resin.
